(19) United States
(12) Patent Application Publication
(10) Pub. No.: US 2025/0285176 A1
(43) Pub. Date: Sep. 11, 2025

(54) DATA TRANSMISSION FROM EDGE TO CLOUD USING EDGE-BASED BIDDING

(71) Applicant: DELL PRODUCTS L.P., Round Rock, TX (US)

(72) Inventors: Balasingh Samuel, Round Rock, TX (US); Farzad Khosrowpour, Pflugerville, TX (US)

(21) Appl. No.: 18/598,463

(22) Filed: Mar. 7, 2024

(51) Int. Cl. G06Q 30/08; H04L 67/10

(52) U.S. Cl. CPC G06Q 30/08; H04L 67/10

(57) ABSTRACT

A remote compute device stores a data collection policy. A processor receives a data request from an application and determines a plurality of data sets within the data request. The processor provides a data bid request to multiple edge compute devices. The processor receives multiple bidding values from the edge compute devices. A different one of the bidding values corresponds to a different one of the edge compute devices. Based on the multiple bidding values and the data collection policy, the processor determines a target edge compute device. The processor provides a data request to the target edge compute device. The processor receives data from the target edge compute device and provide the data to the application.

### FIELD OF THE DISCLOSURE

The present disclosure generally relates to information handling systems, and more particularly relates to data transmission from an edge device to a cloud device using edge-based bidding.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A remote compute device may store a data collection policy. A processor may receive a data request from an application and determine a plurality of data sets within the data request. The processor may provide a data bid request to multiple edge compute devices. The processor may receive multiple bidding values from the edge compute devices. A different one of the bidding values corresponds to a different one of the edge compute devices. Based on the multiple bidding values and the data collection policy, the processor may determine a target edge compute device. The processor may provide a data request to the target edge compute device. The processor may receive data from the target edge compute device and provide the data to the application.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of a system including multiple information handling systems, a remote compute device, a backend server, and multiple edge compute devices according to at least one embodiment of the present disclosure;

FIG. 2 is a flow diagram of a method for performing data transmission from an edge device to a remote compute device based on edge-based bidding according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

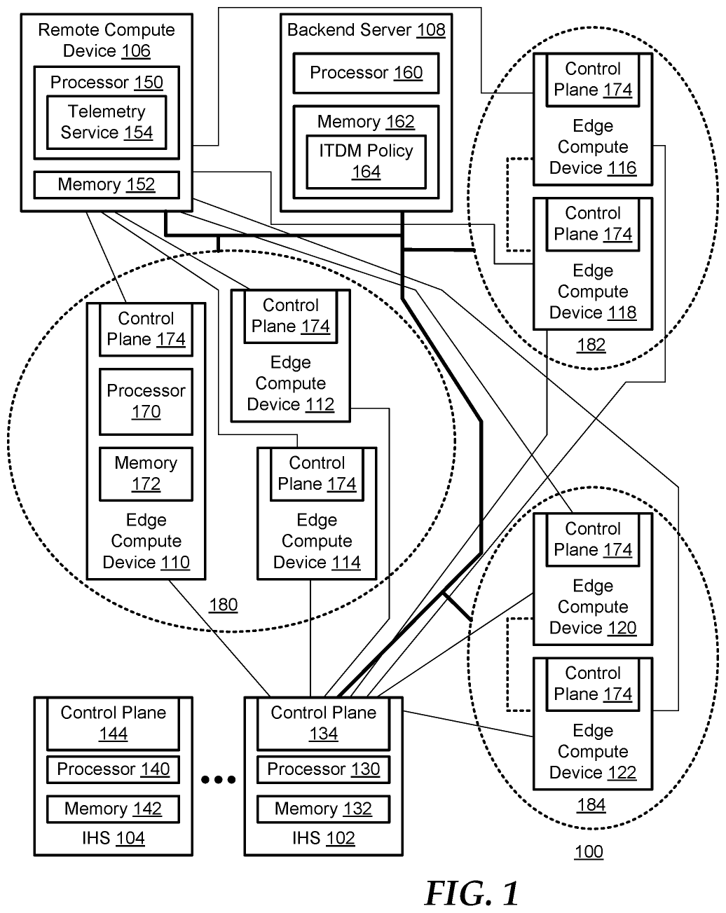

FIG. 1 illustrates a system 100 including multiple information handling systems 102 and 104, a remote compute device 106, backend server 108, and edge compute devices 110, 112, 114, 116, 118, 120, and 122 (110-122) according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes a processor 130, a memory 132, and a control plane 134. Information handling system 104 includes a processor 140, a memory 142, and a control plane 144. Remote compute device 106 includes a processor 150 and a memory 152. Processor 150 may execute any suitable application or service, such as telemetry service 154. Backend server 108 includes a processor 160 and a memory 162. In an example, memory 162 may store any suitable data for system 100 including, but not limited to, a data collection policy, such as an information technology decision maker (ITDM) policy 164. In an example, ITDM policy 164 may include any suitable criteria for edge-bidding in edge compute devices 110-122 including, but not limited to, a best reliability, a best data transmission cost, best carbon footprint, and fastest edge compute device.

Edge compute device 110 includes a processor 170, a memory 172, and a control plane 174. Each of the remaining edge compute devices 112-122 includes a processor, a memory, and a control plane. For clarity and brevity each of edge compute devices 112-122 are illustrated with only a control plane 174. System 100 may include any suitable number of information handling systems, edge compute devices, remote compute devices, and backend servers without varying from the scope of this disclosure. Each of information handling systems 102 and 104, remote compute device 106, backend server 108, and edge compute devices 110-122 may include any suitable components without varying from the scope of this disclosure.

System 100 may be any suitable infrastructure for transferring data between information handling systems edge-cloud infrastructure. In certain examples, edge compute devices 110-122 may be located in different geographic regions, and access to the edge compute devices by information handling systems 102 and 104 may varying based on the location of the geographic regions and the location of the information handling systems. System 100 may include any suitable number of communication channels connected through different networks to provide communication among information handling systems 102 and 104, remote compute device 106, backend server 108, and edge compute devices 110-122. For example, information handling systems 102 and 104 may communicate with to receive/provide data from/to backend server 108 and any and all of edge compute devices 110-122. Remote compute device 106 may communicate with to receive/provide data from/to backend server 108 and any and all of edge compute devices 110-112. Edge compute devices 110-112 may communicate with to receive/provide data from/to each other, information handling systems 102 and 104, remote compute device 106, and backend server 108.

During operation of the devices of system 100, edge compute devices 110-122 may receive data from the end-point devices, such as information handling systems 102 and 104, and perform certain data analytics on the received data. In certain examples, larger deep artificial intelligence-based (AI-based) data analysis may be performed at the cloud level, such as by remote compute device 106. This deep AI-based analysis may be performed by remote compute device 106 based on the remote compute device having access to larger sets of data. While remote compute device 106 is performing the deep AI-based analysis, the remote compute device may request data sets from edge compute devices 110-122. In certain examples, remote compute device 106 may request the data at any suitable points in time, such as periodically, on-demand, or the like. The data set requests may be performed to enable remote compute device 106 to receive data for processing or performing data analysis within remote compute device 106. In certain examples, multiple edge compute devices 110-122 may hold or store the same data in the corresponding memory, such as memory 172 of edge compute device 110. In current edge-cloud infrastructure systems, there is no optimized scheme available for a remote compute device to request data from a proper or correct edge compute device. AI-based data analysis performed by processor 150 may be improved by an edge-based bidding process enabling remote compute device 106 to request the data sets from the right edge compute device 110-122.

In certain examples, edge compute devices 110-122 may be located in different geographic regions 180, 182, and 184. These regions 180, 182, and 184 may be located across a state, a country, or the world. As illustrated in FIG. 1, edge compute devices 110, 112, and 114 may be located in region 180, edge compute devices 116 and 118 may be located in region 182, and edge compute devices 120 and 122 may be located in region 184. In certain examples, remote compute device 106 and backend server 108 may be located within any suitable region, such as region 180. Information handling systems 102 and 104 may be located in any suitable region of system 100. In an example, regions 180, 182, and 184 may include any suitable number of edge compute devices without varying from the scope of this disclosure.

In an example, processor 160 or any other suitable component within backend server 108 may communicate with remote compute device 106 and each control plane 174 of edge compute devices 110 to provide ITDM policy 164 to the remote compute device and the edge compute devices. In response to receiving ITDM policy 164, remote compute device 106 may store the ITDM policy in memory 152 for later use. Similarly, each of edge compute devices 110-122 may store ITDM policy 164 in respective memories, such as memory 172 of edge compute device 110, for later use.

In an example, remote compute device 106 may provide a data bid request to each of edge compute devices 110-122. Based on reception of the data bid request, each of edge compute devices 110-122 may determine a respective bid value. In certain examples, each of edge compute device 110-122 may determine a bid value in substantially the same manner. For clarity and brevity, the determination of a bid value will be described with respect to a single edge compute device, such as edge compute device 110. In an example, processor 170 may perform one or more suitable operations to determine the bid value for edge compute device 110. For example, processor 170 may determine workload load, subsystem health, data transmission cost, carbon intensity, and other factors of edge compute device 110 to determine the bidding value. These factors may provide information about conditions within edge compute device 110 that may affect the ability of the edge compute device to provide telemetry and other data from information handling system 102 to remote compute device 106.

In certain examples, the bidding value may be a numerical value based on an overall ability of edge compute device 110 to provide the telemetry and other data. For example, processor 170 may utilize ITDM policy 164 stored in memory 172 to determine an overall bidding value based on the combination of factors stated above. In an example, the bidding value may be any particular value in a range of bidding values. In one example, as the bidding value increases the ability of edge compute device 110 to provide the telemetry and other data may also increase. In an alternative example, as the bidding value decreases the ability of edge compute device 110 to provide telemetry and other data may increase. In an example, the bidding value may be a set of values and each value may be based on the different factors determined by processor 170. For example, the bidding value may include a value for workload load, a value for subsystem health, a value for data transmission cost, a value for carbon intensity, and values for other factors of edge compute device 110.

In an example, ITDM 164 or any other suitable policy may set a level of granularity for the bidding values. For example, the larger the range of possible bidding values, the larger the granularity. In an example, as the granularity increases for the bidding values, the less likely that multiple edge compute devices 110-122 may provide the same bidding value to remote compute device 106. In this situation, as the number of edge compute devices 110-122 increases within system 100, the granularity of the range of bidding values should increase to prevent the edge compute devices from providing the same bidding value to remote compute device 106. In an example, the bidding value for each of the factors may be any particular value in a range of bidding values. In certain examples, the range for each of the factors may be the same or the range for each of the factors may vary among the factors. In an example, if a workload on processor 170 is above a threshold level, processor 170 may determine that the bidding value for edge compute device 110 should be below a particular value.

In response to receiving the bidding values from each of edge compute devices 110-122, processor 150 in remote compute device 106 may perform any suitable operations to determine a target edge compute device to provide the data request. In an example, processor 150 may utilize ITDM policy 164 stored in memory 152 to determine the target edge compute device. For example, processor 170 may utilize the bidding values from each of edge compute devices 110-122 and criteria in IDTM policy 164 to determine a target edge compute device. IDTM policy 164 may define criteria for processor 170 to determine a target edge compute device based on one or more of a best reliability, a best data transmission cost, best carbon footprint, a fastest edge compute device, or the like.

Based on processor 150 determining a target edge compute device, such as edge compute device 110, the processor may execute telemetry service 154 may communicate over a network to provide the data request to target edge compute device 110. In an example, a data lane may be created between remote compute device 107 and edge compute device 110 and this data lane may be utilized to provide the requested data, such as platform-level hardware data and behavior data, for information handling system 102 to remote compute device 106. In response to receiving the requested data from edge compute device 110, processor 150, via telemetry service 154, may automatically provide the received data to one or more consumer applications in remote compute device 106. Thus, remote compute device 106 and edge compute devices 110-122 may utilize a bidding process to retrieve data for information handling system 102 or 104 from the proper edge compute device of edge compute devices 110-122.

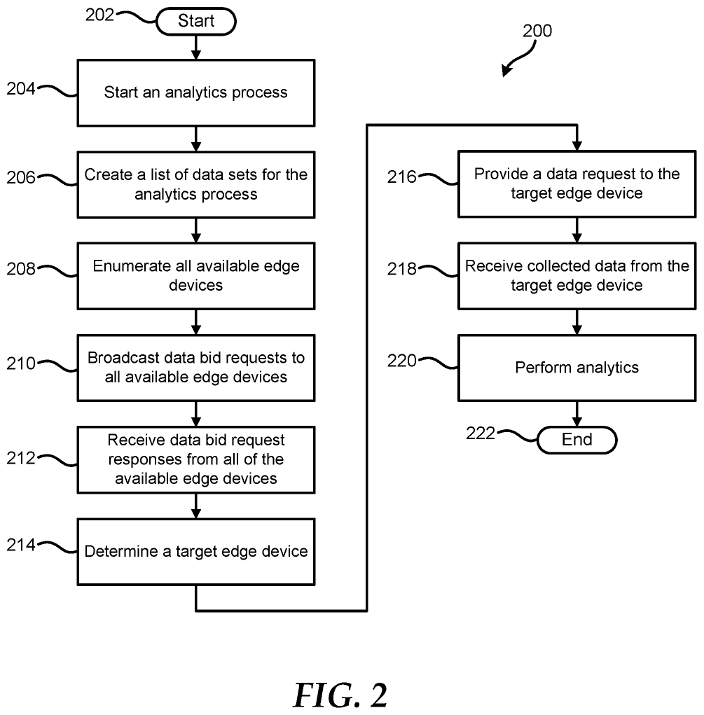

FIG. 2 is a flow diagram of a method 200 for performing data transmission from an edge device to a remote compute device based on edge-based bidding according to at least one embodiment of the present disclosure, starting at block 202. It will be readily appreciated that not every method step set forth in this flow diagram is always necessary, and that certain steps of the methods may be combined, performed simultaneously, in a different order, or perhaps omitted, without varying from the scope of the disclosure. FIG. 2 may be employed in whole, or in part, processor 150 of remote compute device 104, processor 160 of backend server 108, and processors of edge compute devices 110-122, such as processor 170 of edge device 110, in FIG. 1, or any other type of controller, device, module, processor, or any combination thereof, operable to employ all, or portions of, the method of FIG. 2.

At block 204, an analytics process is started. In an example, the analytics process may be started in a remote compute device. In certain examples, the remote compute device may include one or more application, such as AI-based applications to perform the analytics process or operations on data from one or more information handling systems. The data from the information handling system may be any suitable data, such as platform-level data and behavior data. During the analytics operations, the applications in the remote compute device may need additional data.

At block 206, a list of data sets for the analytics process is created. In an example, the list of data sets may include any suitable information to identify the data sets needed by the applications to continue performing the analytics process or operations. A processor of the remote compute device may need different data sets based on the analytics operations being performed by the applications in the remote compute device. In certain examples, the list of data sets may be stored in a memory of the remote compute device.

At block 208, all available edge compute devices are enumerated. In certain examples, multiple edge compute devices in an IT infrastructure system may include the same data from one or more information handling systems of the system. In an example, remote compute devices may determine the available edge compute devices by determining which edge compute devices in an IT infrastructure system are currently powered on and actively communicating with other devices of the system.

At block 210, data bid requests are broadcasted to all available edge compute devices. In an example, remote compute device may provide the data bid requests to all available edge compute devices by one or more network connections and the control planes of the edge compute devices. At block 212, data bid request responses are received from all of the available edge compute devices. In certain examples, the edge compute devices may determine a bidding value based on workload load, subsystem health, data transmission cost, carbon intensity, and other factors of edge compute device. These factors may provide information about conditions within the edge compute device that may affect the ability of the edge compute device to provide telemetry and other data from the information handling system to the remote compute device.

In certain examples, the bidding value may be a numerical value based on an overall ability of the edge compute device to provide the telemetry and other data. For example, the edge compute device may utilize an ITDM policy to determine an overall bidding value based on the combination of factors stated above. In an example, the bidding value may be a set of values and each value may be based on the different factors determined by a processor of the edge compute device.

At block 214, a target edge device is determined. In an example, a processor of the remote compute device may perform any suitable operations to determine the target edge compute device. For example, the remote compute device may determine the target edge compute device based on the received bidding values from the edge compute devices. The remote compute device may also utilize the ITDM policy for the IT infrastructure system to determine the target edge compute device.

At block 216, the data request is provided to the target edge compute device. In an example, the remote compute device may execute telemetry service may communicate over a network to provide the data request to the target edge compute device. In certain examples, a data lane may be created between the remote compute device and the edge compute device and this data lane may be utilized to provide the requested data, such as platform-level hardware data and behavior data, to the target remote compute device.

At block 218, collected data is received from the target edge compute device. At block 220, the analytics process is performed and the flow ends at block 222. In response to receiving the requested data from the edge compute device, the remote compute device may automatically provide the received data to one or more consumer applications. In an example, the applications may performed AI-based data analytics operations on the data received from the target edge compute device.

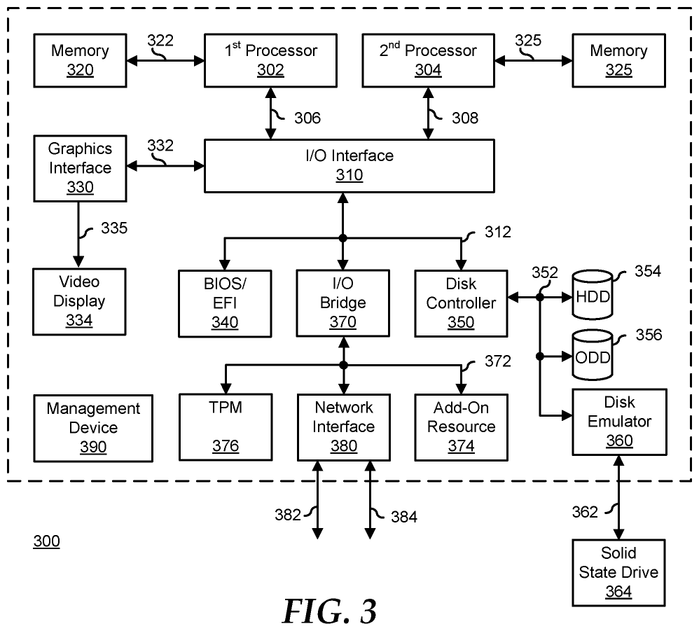

FIG. 3 shows a generalized embodiment of an information handling system 300 according to an embodiment of the present disclosure. Information handling system 300 may be substantially similar to information handling system 102, remote compute device 104, backend server 108, and edge device 170 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A remote compute device comprising:
a memory to store a data collection policy; and
a processor to communicate with the memory, the processor to:
receive a data request from an application;
determine a data set within the data request;
provide a data bid request to multiple edge compute devices;
receive multiple bidding values from the edge compute devices, wherein a different one of the bidding values corresponds to a different one of the edge compute devices;
based on the multiple bidding values and the data collection policy, determine a target edge compute device;
provide a data request for the data set to the target edge compute device;
receive the data set from the target edge compute device; and
provide the data set to the application.

2. The remote compute device of claim 1, wherein the processor further to: receive the data collection policy from a backend server, the backend server is in communication with the remote compute device, the multiple edge compute devices, and multiple information handling systems.

3. The remote compute device of claim 1, wherein prior to the data request being provided to the target edge compute device, the processor further to: create a data lane between the remote compute device and the target edge compute device, wherein the data is received from the target edge compute device over the data lane.

4. The remote compute device of claim 1, wherein each of the multiple edge compute devices include the data set.

5. The remote compute device of claim 1, wherein the data collection policy includes a level of granularity for the bidding values.

6. The remote compute device of claim 1, wherein the each different one of the bidding values are based on workload load, subsystem health, data transmission cost, and carbon intensity of a corresponding different one of the edge compute devices.

7. The remote compute device of claim 1, wherein the data collection policy includes a reliability, a data transmission cost, carbon footprint, and speed for an edge compute device.

8. The remote compute device of claim 1, wherein the application is an artificial intelligence based data analysis application.

9. A method comprising:
storing, by a processor of a remote compute device, a data collection policy in a memory;
receiving a data request from an application;
determining a plurality of data sets within the data request;
providing a data bid request to multiple edge compute devices;
receiving multiple bidding values from the edge compute devices, wherein a different one of the bidding values corresponds to a different one of the edge compute devices;
based on the multiple bidding values and the data collection policy, determining a target edge compute device;
providing a data request for the data set to the target edge compute device;
receiving, by the processor, the data set from the target edge compute device; and
providing the data set to the application.

10. The method of claim 9, further comprising receiving the data collection policy from a backend server, the backend server is in communication with the remote compute device, the multiple edge compute devices, and multiple information handling systems.

11. The method of claim 9, wherein prior to the data request being provided to the target edge compute device, the processor further to: creating a data lane between the remote compute device and the target edge compute device, wherein the data is received from the target edge compute device over the data lane.

12. The method of claim 9, wherein each of the multiple edge compute devices include the data set.

13. The method of claim 9, wherein the data collection policy includes a level of granularity for the bidding values.

14. The method of claim 9, wherein the each different one of the bidding values are based on workload load, subsystem health, data transmission cost, and carbon intensity of a corresponding different one of the edge compute devices.

15. The method of claim 9, wherein the data collection policy includes a reliability, a data transmission cost, carbon footprint, and speed for an edge compute device.

16. The method of claim 9, wherein the application is an artificial intelligence based data analysis application.

17. A remote compute device comprising:
a memory to store a data collection policy, wherein the data collection policy is received from a backend server; and
a processor to:
receive a data request from an application;
determine a data set within the data request;
provide a data bid request to multiple edge compute devices;
receive multiple bidding values from the edge compute devices, wherein a different one of the bidding values corresponds to a different one of the edge compute devices;
based on the multiple bidding values and the data collection policy, determine a target edge compute device;
provide a data request for the data set to the target edge compute device;
create a data lane between the remote compute device and the target edge compute device;
receive the data set from the target edge compute device over the data lane; and
provide the data set to the application.

18. The remote compute device of claim 17, wherein each of the multiple edge compute devices include the data set.

19. The remote compute device of claim 17, wherein the each different one of the bidding values are based on workload load, subsystem health, data transmission cost, and carbon intensity of a corresponding different one of the edge compute devices.

20. The remote compute device of claim 17, wherein the data collection policy includes a level of granularity for the bidding values.
